(19) United States
(12) Patent Application Publication
(10) Pub. No.: US 2008/0190697 A1
(43) Pub. Date: Aug. 14, 2008

(54) Ladder Leveling System

(76) Inventor: Albert R. Skurkis, Ranier, MN (US)

Correspondence Address: NEUSTEL LAW OFFICES, LTD., 2534 SOUTH UNIVERSITY DRIVE, SUITE 4, FARGO, ND, 58103, US

(21) Appl. No.: 11/673,043

(22) Filed: Feb. 9, 2007

(51) Int. Cl. E06C 7/00

(52) U.S. Cl. 182/204; 182/201

(57) ABSTRACT

A ladder leveling system for efficiently leveling a ladder positioned upon uneven terrain. The ladder leveling system generally includes an extension member including a channel and at least one slot. At least one bracket is positioned adjacent the extension member, wherein the channel extends between the bracket and the extension member and wherein the bracket includes an aperture. At least one attachment member extends through the aperture and the slot, wherein the attachment member is selectively secured within the slot and wherein the attachment member secures the bracket to the extension member.

### CROSS REFERENCE TO RELATED APPLICATIONS

Not applicable to this application.

### STATEMENT REGARDING FEDERALLY SPONSORED RESEARCH OR DEVELOPMENT

Not applicable to this application.

### BACKGROUND OF THE INVENTION

1. Field of the Invention

The present invention relates generally to ladders and more specifically it relates to a ladder leveling system for efficiently leveling a ladder positioned upon uneven terrain.

2. Description of the Related Art

Any discussion of the prior art throughout the specification should in no way be considered as an admission that such prior art is widely known or forms part of common general knowledge in the field.

Ladders have been in use for years. Typically, ladders may be manufactured in various structures, wherein a common structure of a ladder is generally referred to as a rigid structure. These ladders may be comprised of various configurations, such as but not limited to extension ladders, step ladders or fixed ladders. The ladders generally consist of a pair of vertical members or legs connected by a plurality of rungs, wherein the rungs are vertically stacked about the vertical members.

Generally ladders are utilized in a wide variety of situations, wherein many of these situations include positioning the ladder upon an uneven ground surface. This can be very dangerous for the people climbing the ladder. There are prior art leveling devices utilized with ladders; however these prior art leveling devices are generally difficult to adjust and/or do not adequately attach to various types of ladders. Because of the general lack of efficiency and practicality in the prior art there is the need for a new ladder leveling system for efficiently leveling a ladder positioned upon uneven terrain.

### BRIEF SUMMARY OF THE INVENTION

The general purpose of the present invention is to provide a ladder leveling system that has many of the advantages of the ladders mentioned heretofore. The invention generally relates to a ladder which includes an extension member including a channel and at least one slot. At least one bracket is positioned adjacent the extension member, wherein the channel extends between the bracket and the extension member and wherein the bracket includes an aperture. At least one attachment member extends through the aperture and the slot, wherein the attachment member is selectively secured within the slot and wherein the attachment member secures the bracket to the extension member.

There has thus been outlined, rather broadly, some of the features of the invention in order that the detailed description thereof may be better understood, and in order that the present contribution to the art may be better appreciated. There are additional features of the invention that will be described hereinafter and that will form the subject matter of the claims appended hereto.

In this respect, before explaining at least one embodiment of the invention in detail, it is to be understood that the invention is not limited in its application to the details of construction or to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

An object is to provide a ladder leveling system for efficiently leveling a ladder positioned upon uneven terrain.

Another object is to provide a ladder leveling system that attaches to various types of ladders.

An additional object is to provide a ladder leveling system that easily adjusts to accommodate various terrains.

A further object is to provide a ladder leveling system that securely attaches to a ladder.

Other objects and advantages of the present invention will become obvious to the reader and it is intended that these objects and advantages are within the scope of the present invention. To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is an exploded upper perspective view of the present invention.

FIG. 2 is an upper perspective view of the present invention attached to a ladder.

FIG. 3 is an exploded upper perspective view of a first alternative embodiment of the present invention.

FIG. 4 is an upper perspective view of the first alternative embodiment of the present invention attached to a ladder.

FIG. 5 is an exploded upper perspective view of a second alternative embodiment of the present invention.

FIG. 6 is an upper perspective view of the second alternative embodiment of the present invention attached to a ladder.

FIG. 7 is an exploded upper perspective view of a third alternative embodiment of the present invention.

FIG. 8 is an upper perspective view of the third alternative embodiment of the present invention attached to a ladder.

FIG. 9 is a cross-sectional view of the present invention.

FIG. 10 is a front view of the present invention attached to a ladder with the ladder positioned upon an uneven surface.

FIG. 11 is a front view of the present invention attached to a ladder with the ladder positioned upon an uneven surface and the present invention adjusted to accommodate for the uneven surface.

### DETAILED DESCRIPTION OF THE INVENTION

### A. Overview

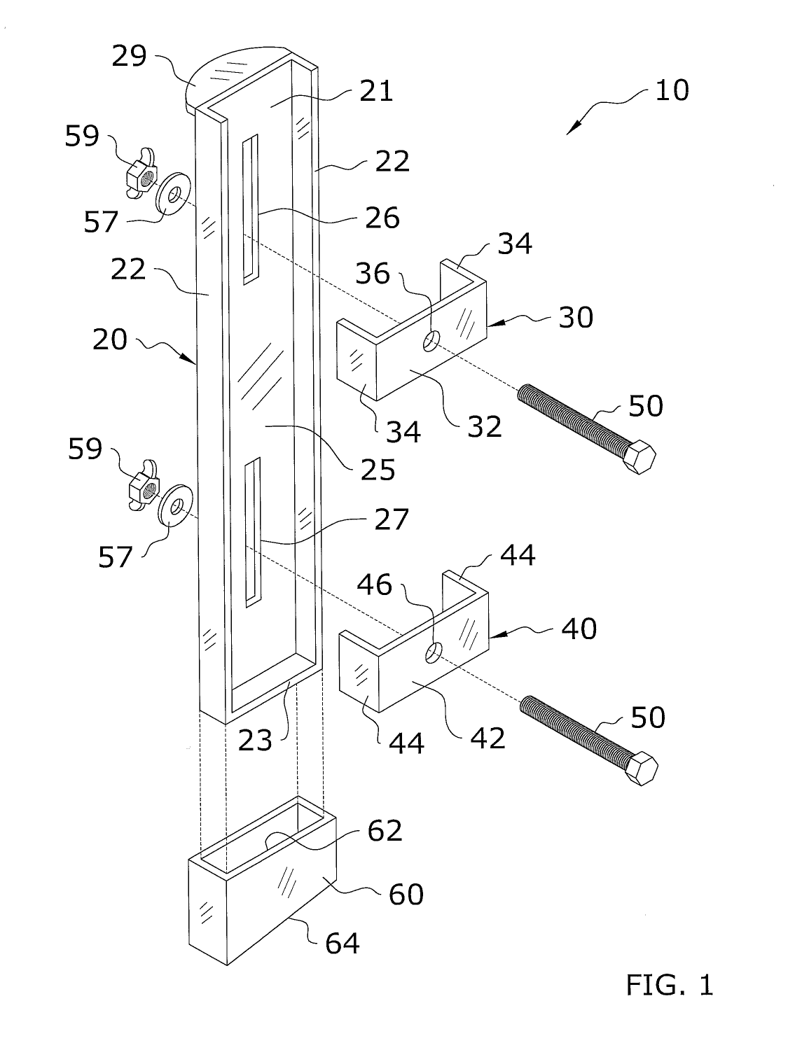

Turning now descriptively to the drawings, in which similar reference characters denote similar elements throughout the several views, FIGS. 1 through 11 illustrate a ladder leveling system 10, which comprises an extension member 20 including a channel 25 and at least one slot 26, 27. At least one bracket 30, 40 is positioned adjacent the extension member 20, wherein the channel 25 extends between the bracket 30, 40 and the extension member 20 and wherein the bracket 30, 40 includes an aperture 26, 36. At least one attachment member 50 extends through the aperture 26, 36 and the slot 26, 27, wherein the attachment member 50 is selectively secured within the slot 26, 27 and wherein the attachment member 50 secures the bracket 30, 40 to the extension member 20.

The ladder is comprised of a rigid structured common in the art of ladders, such as but not limited to an extension ladder or a step ladder. The ladder includes a pair of legs 12 vertically oriented and a plurality of rungs 14 attaching the pair of legs 12. The rungs 14 are vertically stacked about the legs 12 and serve as steps for the user to climb the ladder.

The present invention is also preferably attached to both opposing legs 12 of the ladder to allow the user to slidably adjust the present invention about either leg 12. The present invention is also preferably interchangeable upon opposing legs 12 of the ladder to allow for simple attachment and to reduce costs of manufacturing. The below description describes the structure and function of a single ladder leveling system 10; however it is appreciated that both ladder leveling systems 10 attached to opposing legs 12 of the ladder are comprised of substantially similar configurations.

### B. Extension Member

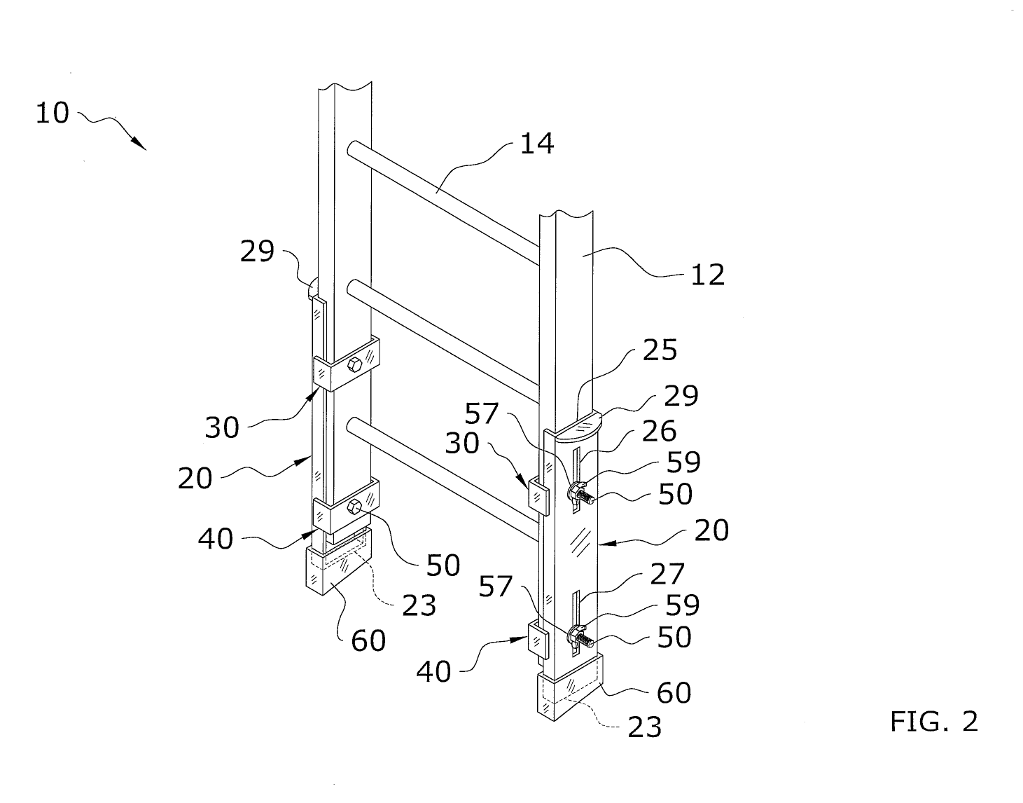

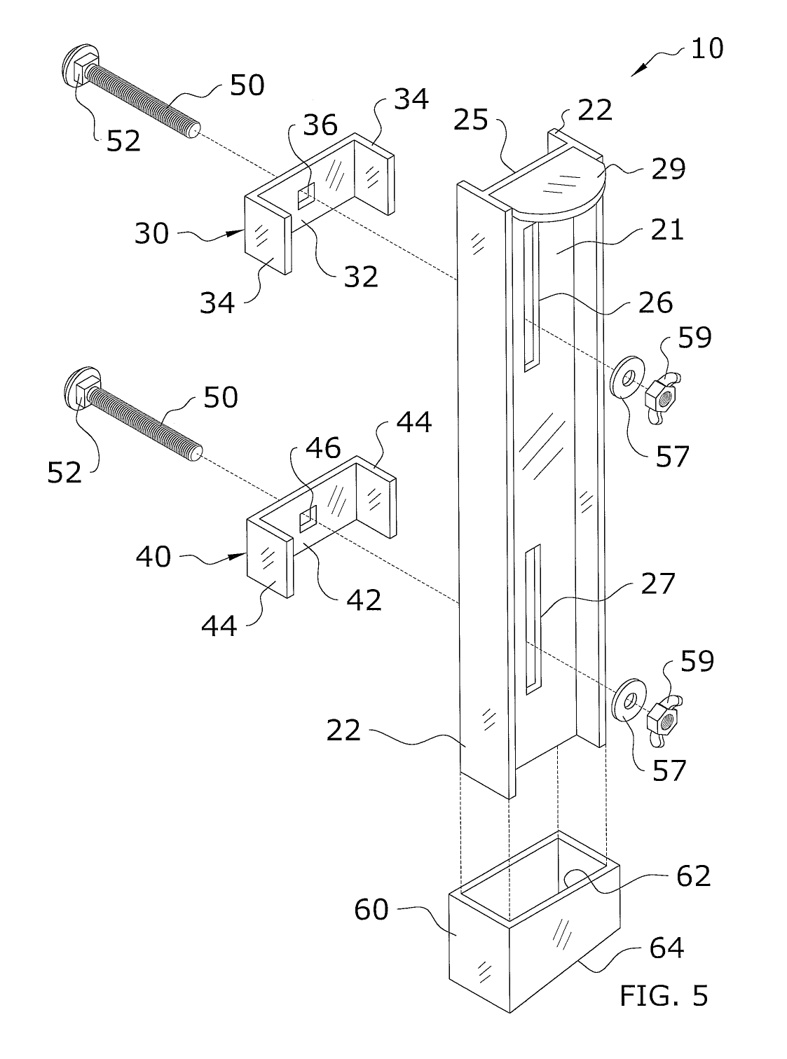

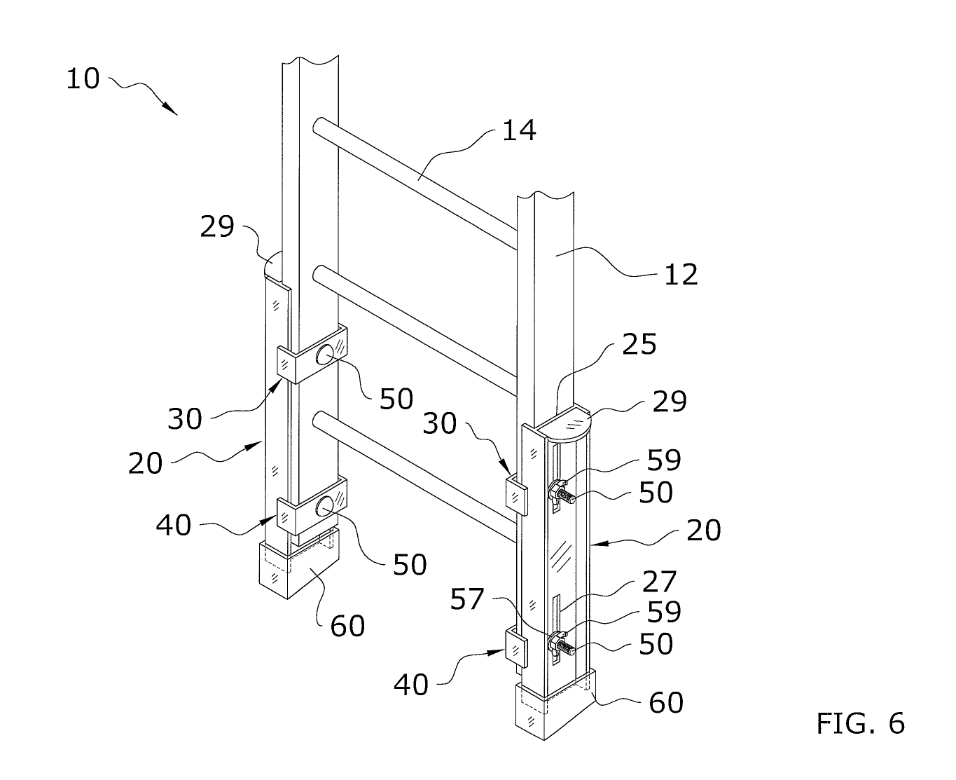

The extension member 20 is comprised of an elongated structure to slidably adjust about a lower end of the legs 12 of the ladder as illustrated in FIGS. 2, 4, 6 and 8. The extension member 20 may be comprised of various materials, such as but not limited to plastic, metal, wood, aluminum, fiberglass or a type of resin material. The extension member 20 is further preferably comprised of a material that may withstand large amounts of weight upon the attached ladder (i.e. ladder's capacity weight) and also withstand harsh weather conditions. As illustrated in FIGS. 1 and 2, the extension member 20 is comprised of a U-shaped configuration. It is appreciated however that the extension member 20 may be comprised of various shaped configurations, such as but not limited to an I-shaped configuration as illustrated in FIGS. 5 and 6. The extension member 20 may further be colored to various colors to match the ladder.

The extension member 20 includes a support portion 21, a pair of side portions 22 attached to opposing ends of the support portion 21 and channel 25 extending between the side portions 22 and the support portion 21 as illustrated in FIGS. 1, 3, 5 and 7. The support portion 21 and the side portions 22 are preferably comprised of an integrally formed structure; however it is appreciated that the support portion 21 and the side portions 22 may be comprised of separate structures. The side portions 22 may also be comprised of various widths. The side portions 22 preferably do not extend past the legs 12 of the ladder when the ladder is positioned within the channel 25 to allow the bracket 30, 40 to grasp the leg 12 from the opposing side. The channel 25 is also preferably comprised of a substantially similar configuration as the leg 12 of the ladder to provide a secure fit between the extension member 20 and the leg 12 of the ladder.

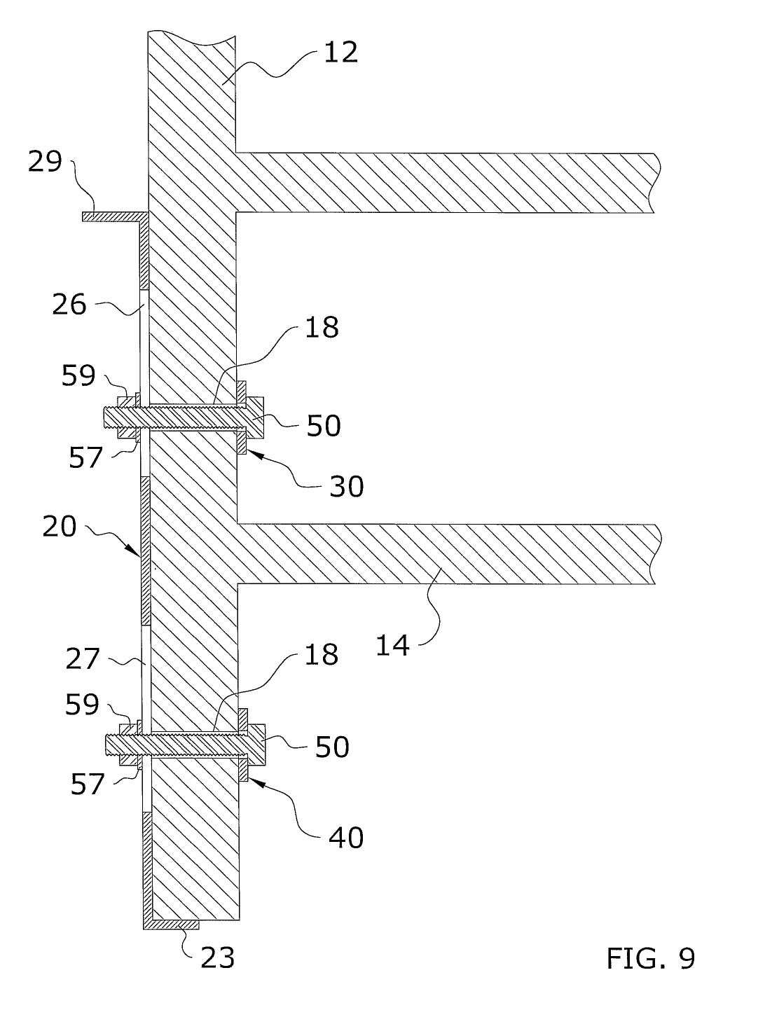

The extension member 20 also preferably includes a base portion 23 extending across a lower end of the extension member 20 as illustrated in FIGS. 1, 3, 5 and 7. The base portion 23 preferably receives the foot member 60. The base portion 23 is preferably comprised of a flat configuration; however it is appreciated that the base portion 23 may be comprised of various configurations. The base portion 23 and the extension member 20 are preferably comprised of an integrally formed structure; however it is appreciated that the base portion 23 and the extension member 20 may be comprised of separate structures. The lower end of the leg 12 of the ladder is also preferably positioned adjacent the base portion 23 as shown in FIG. 9.

The extension member 20 also preferably includes a handle portion 29 extending outwardly from an upper end of the extension member 20. The handle portion 29 further preferably extends outwardly from the extension member 20 away from the leg 12 of the ladder. The handle portion 29 is preferably comprised of a tab configuration as shown in FIG. 1. The user preferably slides the extension member 20 about the leg 12 of the ladder by the handle portion 29. The handle portion 29 may be comprised of various configurations all which allow the user to easily grasp the handle portion 29.

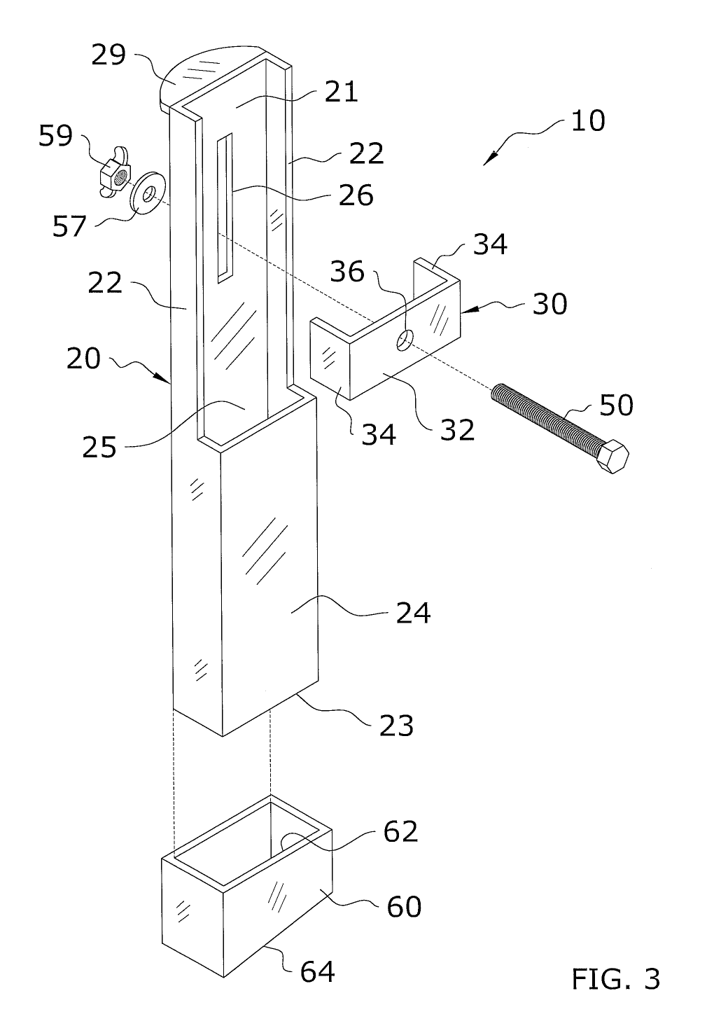

The extension member 20 also preferably includes at least one slot 26, 27 extending through the support portion 21 to allow a fastener 66 and the attached leg 12 of the ladder to slidably adjust about the extension member 20 via the slot 26, 27. In the preferred embodiment of the present invention, the extension member 20 includes an upper slot 26 and a lower slot 27 as shown in FIG. 1. It is appreciated that the support portion 21 may include just the upper slot 26 or just the lower slot 27 as shown in FIGS. 3, 4, 7 and 8. It is further appreciated that the support portion 21 may include a plurality of slots 26, 27.

The upper slot 26 and the lower slot 27 are preferably comprised of substantially similar configurations. The upper slot 26 and the lower slot 27 are also preferably vertically stacked about the support portion 21 of the extension member 20. The upper slot 26 and the lower slot 27 are further preferably comprised of elongated structures. The upper slot 26 and the lower slot 27 are also preferably positioned along a center axis of the support portion 21 as shown in FIG. 1. The slots 26, 27 are also comprised of a sufficient length to allow the extension member 20 to adequately level a ladder positioned upon an uneven ground surface 16.

In the first and third alternative embodiments of the present invention the extension member 20 includes a sleeve portion 24 as shown in FIGS. 3, 4, 7 and 8. The sleeve portion 24 connects the pair of side portions 22 opposite the support portion 21. The sleeve portion 24 preferably extends from a lower end of the extension member 20 to substantially near a vertical center of the extension member 20.

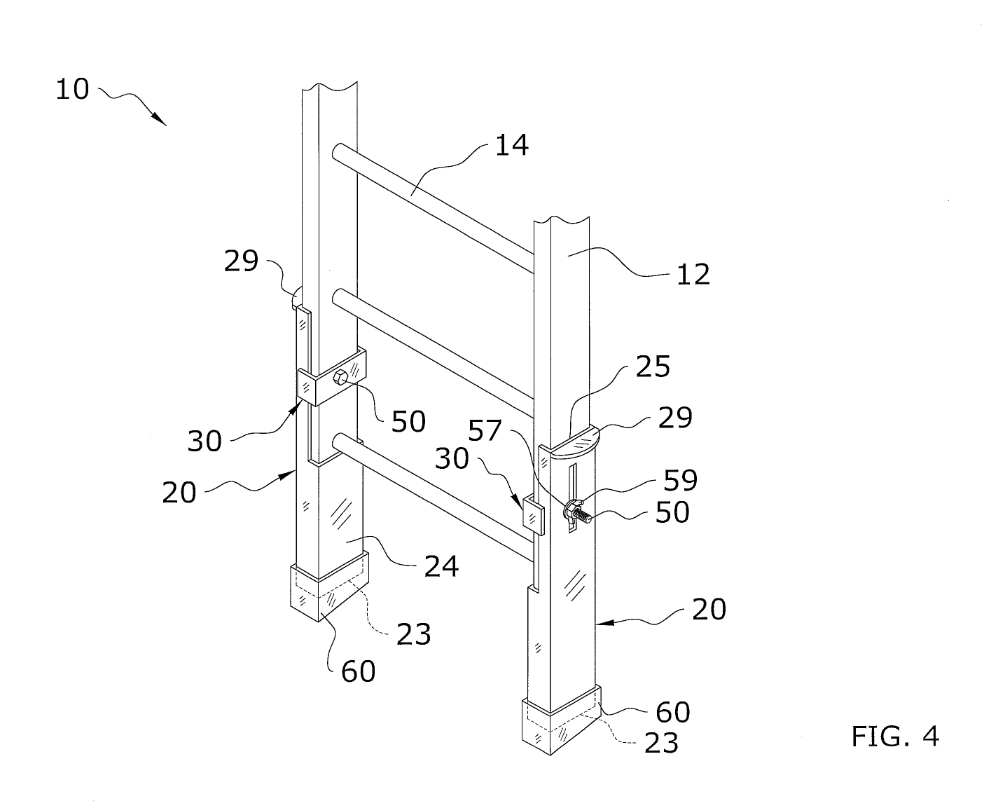

The sleeve portion 24 serves to adequately secure the leg 12 of the ladder within the extension member 20 as illustrated in FIG. 4, wherein a distance from the sleeve portion 24 to the support portion 21 is substantially similar to the depth of the leg 12 of the ladder. Further, the channel 25 preferably extends between the sleeve portion 24 and the support portion 21. The sleeve portion 24 and the extension member 20 are preferably comprised of an integrally formed structure; however it is appreciated that the sleeve portion 24 and the extension member 20 may be comprised of separate structures.

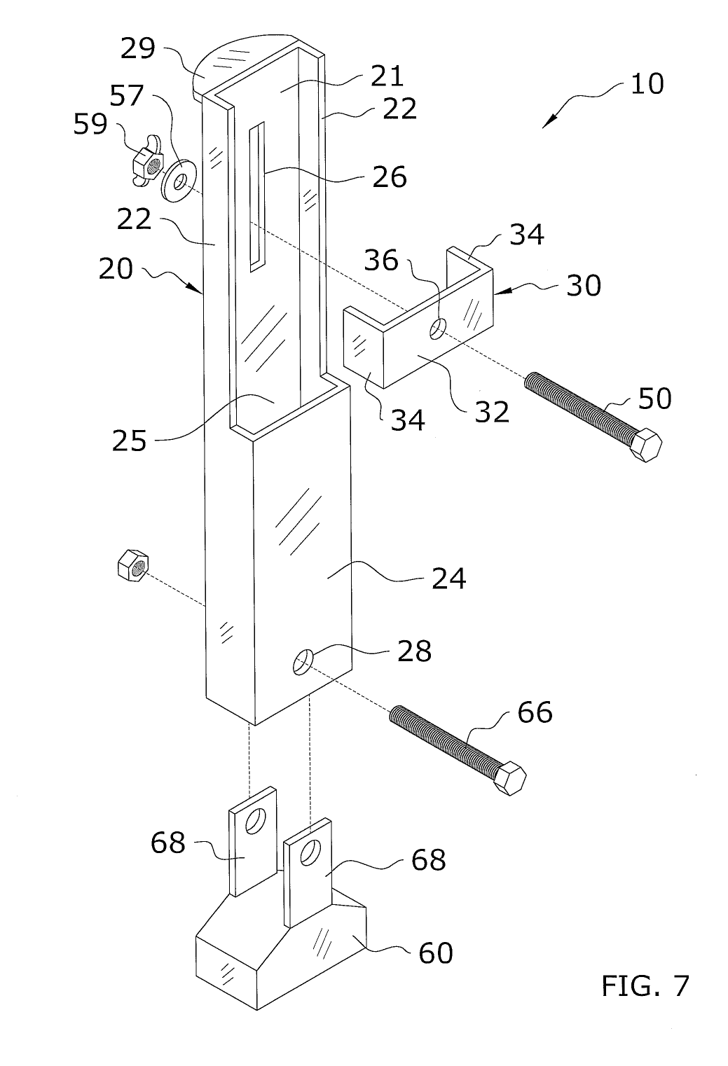

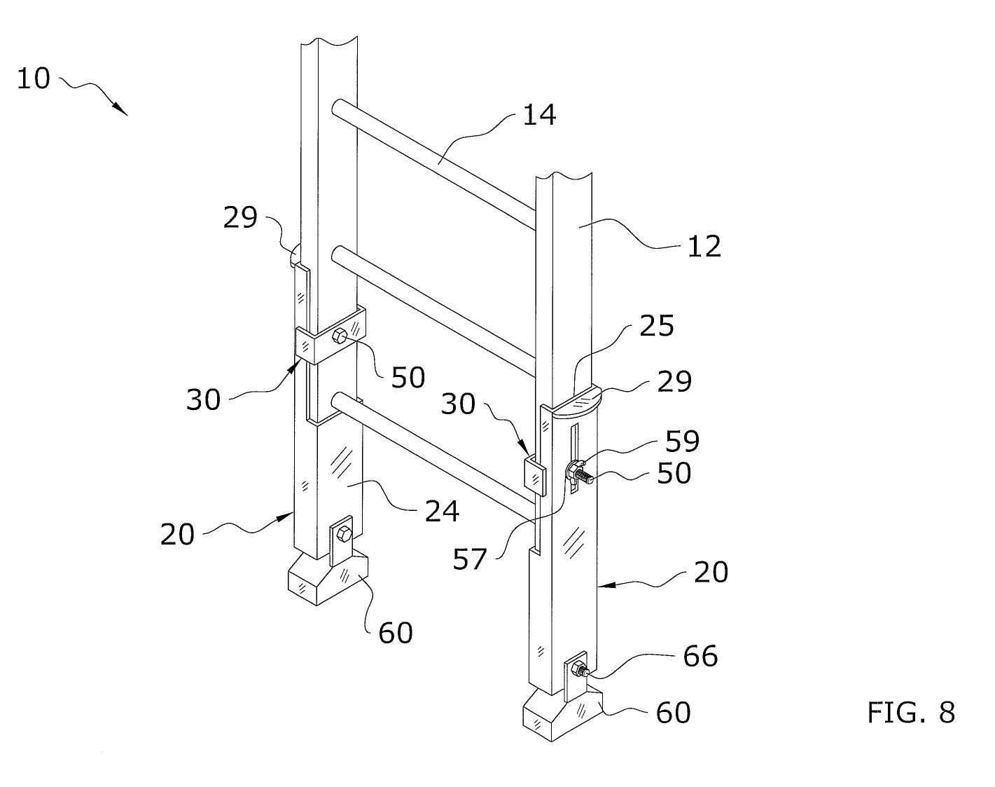

The extension member 20 may also includes a receiving aperture 28 extending through the base portion 23 of the extension member 20 as illustrated in FIGS. 7 and 8. The receiving aperture 28 preferably receives a fastener 66, wherein the fastener 66 attaches a foot member 60 to the base portion 23 of the extension member 20. It is appreciated that the extension member 20 may be comprised of various configurations, some which are not displayed in the drawings, all which adequately receive the leg 12 of the ladder. It is also appreciated that various embodiments of the present invention may be mixed and matched, wherein each particular embodiment is not limited and separated from other embodiments.

### C. Brackets

The brackets 30, 40 of the present invention attach to the extension member 20 and sandwich the leg 12 of the ladder between the brackets 30, 40 and the support portion 21 of the extension member 20 as illustrated in FIGS. 2, 4, 6, 8 and 9. The bracket 30, 40 may be comprised of various materials, such as but not limited to plastic, metal or wood. The bracket 30, 40 is further preferably comprised of a material that may withstand large amounts of weight upon the attached ladder and also withstand harsh weather conditions.

The brackets 30, 40 may include an upper bracket 30 and a lower bracket 40 or simply an upper bracket 30 or a lower bracket 40. The bracket 30, 40 and the extension member 20 are preferably comprised of separate structures; however it is appreciated that the bracket 30, 40 and the extension member 20 may be comprised of an integrally formed structure.

It is appreciated that the present invention may include one bracket 30, 40 as illustrated in FIGS. 3, 4, 7 and 8. The present invention may also include a pair of brackets 30, 40 as illustrated in FIGS. 1, 2, 5 and 6. Generally, the embodiments of the present invention that include the sleeve portion 24 subsequently include one bracket 30, 40, wherein the sleeve portion 24 serves as the second bracket 30, 40. Likewise, the embodiments that do not include the sleeve portion 24 include two bracket 30,s 40 to secure the leg 12 of the ladder to the present invention. It is also appreciated that the present invention may include more than two brackets 30, 40 when further support is needed to attach the leg 12 of the ladder to the present invention.

The bracket 30, 40 is preferably comprised of U-shaped configuration as illustrated in FIGS. 1 through 8, wherein the bracket 30, 40 wraps around the leg 12 of the ladder and forms a cincture structure with the extension member 20 around the leg 12 of the ladder. The bracket 30, 40 also includes a cross portion 32, 42 and an extending portion 34, 44. The cross portion 32, 42 preferably extends across the inner surface of the leg 12 of the ladder. The extending portion 34, 44 preferably extends across opposing ends of the leg 12 of the ladder adjacent to the inner surface as illustrated in FIGS. 2, 4, 6 and 8.

The cross portion 32, 42 of the bracket 30, 40 preferably includes an aperture 36, 46 extending through a substantial center of the cross portion 32, 42. The aperture 36, 46 receives the attachment member 50 when attaching the bracket 30, 40 to the extension member 20. The aperture 36, 46 may be comprised of various configurations, such as but not limited to square as shown in FIG. 5 and circular as shown in FIG. 1, 3 and 7. The configuration of the aperture 36, 46 further preferably matches up with the configuration of the securing portion 52 of the attachment member 50 as illustrated in FIGS. 1, 3, 5 and 7. The aperture 36, 46 further aligns with the slot of the support portion 21.

### D. Attachment Member

The attachment member 50 removably attaches the bracket 30, 40, the leg 12 of the ladder and the extension member 20 together. The attachment member 50 may be comprised of various configurations, such as but not limited to a bolt as shown in FIGS. 1 through 9. The attachment member 50 is also comprised of an elongated structure to extend through the aperture 36, 46 of the bracket 30, 40, the hole 18 of the leg 12 of the ladder and the slot 26, 27 of the extension member 20. A hole 18 is also preferably drilled through the leg 12 of the ladder of adequate size to receive the attachment member 50.

The attachment member 50 includes a securing portion 52 and a threaded portion. The securing portion 52 may be comprised of various configurations such as rectangular or circular, wherein the configuration of the securing portion 52 preferably mimics the configuration of the aperture 36, 46. The threaded portion threadably receives a securing member 59 a shown in FIGS. 1 through 9.

The securing member 59 may be comprised of various configurations, such as but not limited to a standard nut or a wing nut. The attachment member 50 may also include various washers 57 to provide a more secure attachment between the leg 12 of the ladder and the present invention.

### E. Foot Member

The present invention also preferably includes a foot member 60 attached to the base portion 23 of the extension member 20. The foot member 60 is further preferably removably attached to the base portion 23. The foot member 60 and the extension member 20 are preferably comprised of separate structures; however it is appreciated that the foot member 60 and the extension member 20 may be comprised of an integrally formed structure.

The foot member 60 may be comprised of various configurations as shown in FIGS. 1 through 8. In a first configuration of the foot member 60, the foot member 60 resembles a boot that slidably attaches upon the base portion 23 of the extension member 20 and includes a cavity portion 62 and a lower surface 64.

In the first configuration, the cavity portion 62 is preferably comprised of a substantially similar configuration as the base portion 23 as shown in FIGS. 1, 3 and 5. The lower surface 64 is preferably comprised of an inclined configuration, wherein the incline of the lower surface 64 parallels the ground surface 16 when the present invention is in use.

In a second configuration of the foot member 60, the foot member 60 is preferably comprised of a standard foot member 60 present upon extension ladders as illustrated in FIGS. 7 and 8. In this embodiment of the foot member 60, the foot member 60 is first removed from the extension ladder when attaching the leg 12 of the ladder to the extension member 20 and the bracket 30, 40. The foot member 60 is then reattached to the base portion 23 of the extension member 20 via extending a fastener 66 through an attachment portion 68 of the foot member 60 and the receiving aperture 28 of the base portion 23. In the second configuration, the foot member 60 is also preferably pivotally attached to the extension member 20.

### F. Assemblage of the Present Invention

It is appreciated the present invention may be assembled in various ways according to each specific embodiment chosen. The below description simply attempts to describe one way to assemble the present invention.

During assemblage, any foot members 60 present upon the leg 12 of the ladder are first removed to allow the leg 12 of the ladder to be positioned within the channel 25 of the extension member 20. The lower end of the leg 12 of the ladder is then positioned within the channel 25 of the extension member 20 and the extension member 20 and slots 26, 27 are utilized as a template for the holes 18 of the legs 12. A first marking is marked upon the outer surface of the leg 12 of the ladder, wherein the first marking aligns with the upper slot 26 or the lower slot 27.

If both the upper slot 26 and the lower slot 27 are being utilized, a second marking is marked within the other slot 26, 27 at a substantially similar position within the slot 26, 27 as the first marking. The leg 12 of the ladder may now be removed from the channel 25 and a hole 18 is drilled through the leg 12 of the ladder about the first marking and the second marking. The leg 12 of the ladder may now be repositioned within the channel 25 aligning the holes 18 with the slots 26, 27.

The brackets 30, 40 are now positioned about the ladder opposite the extension member 20, wherein the extending portion 34, 44 extends toward the extension member 20 and the aperture 36, 46 aligns with the hole 18 of the leg 12 of the ladder. An attachment member 50 is now extended through the aperture 36, 46 of the bracket 30, 40, the hole 18 of the ladder and the slot 26, 27 of the extension member 20.

Any washers 57 desired may also be positioned about the attachment member 50. The fastener 66 is now threadably attached to the threaded portion of the attachment member 50 and securely fastened. The foot member 60 may now be attached to the base portion 23 of the extension member 20. The above process may now be repeated for the other leg 12 of the ladder.

### G. In Use

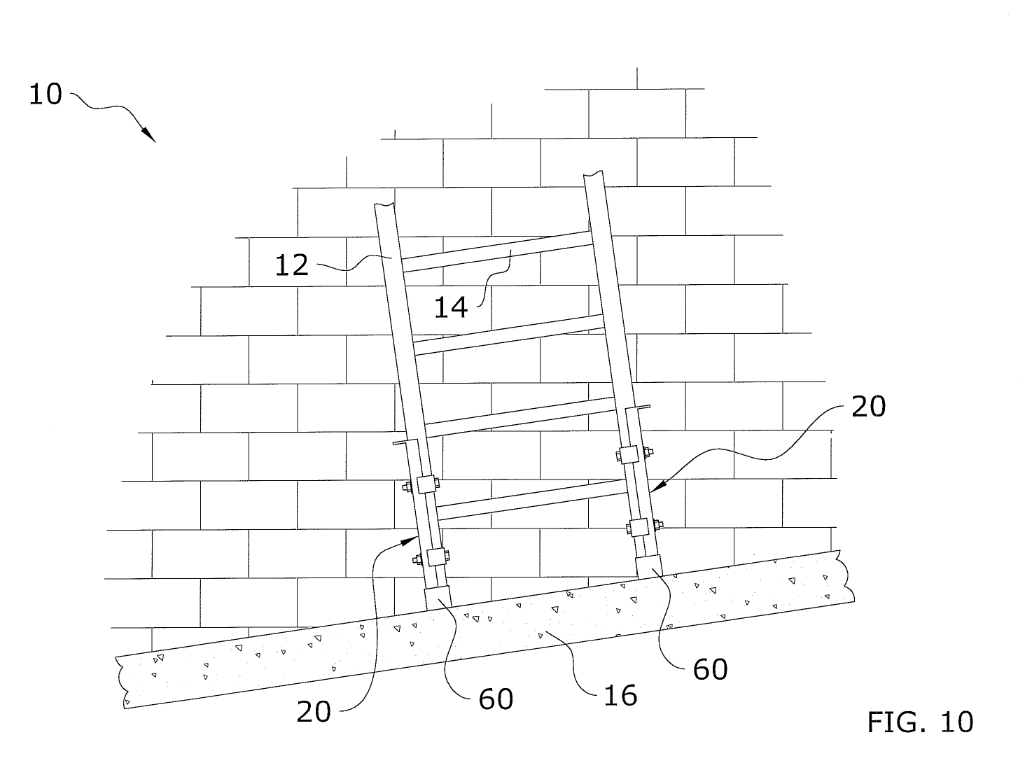

In use, the present invention and attached ladder are first positioned at the desired climbing spot as shown in FIG. 10. If the ground surface 16 is uneven and the ladder is tilted, the extension member 20 attached to the vertically lower leg 12 of the ladder is preferably adjusted. To adjust the extension member 20 the fastener 66 is first loosened about the attachment member 50 to a point where the leg 12 of the ladder may slide between the bracket 30, 40 and the extension member 20.

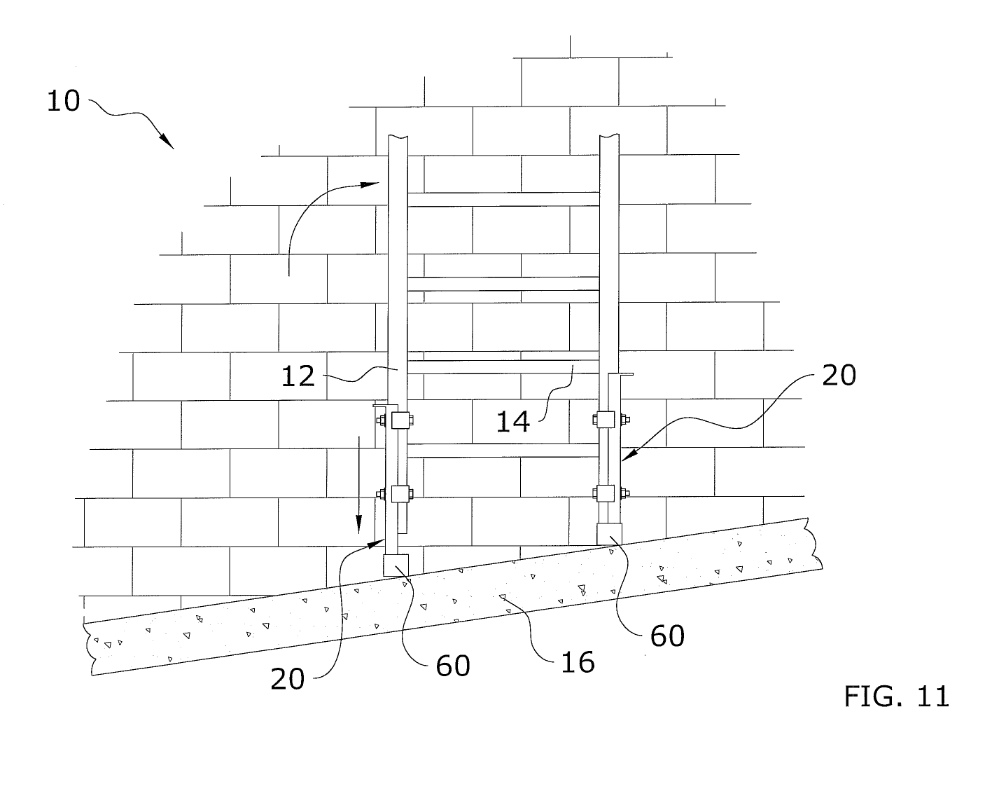

The leg 12 of the ladder is now slidably adjusted about the slots 26, 27 and within the extension member 20. The extension member 20 slides about the leg 12 of the ladder via grasping the handle portion 29 and moving the present invention vertically about the legs 12. The extension member 20 is adjusted until the rungs 14 of the ladder are substantially level as illustrated in FIG. 11. The fastener 66 may now be retightened about the attachment member 50. The ladder may now be utilized in a normal manner.

What has been described and illustrated herein is a preferred embodiment of the invention along with some of its variations. The terms, descriptions and figures used herein are set forth by way of illustration only and are not meant as limitations. Those skilled in the art will recognize that many variations are possible within the spirit and scope of the invention, which is intended to be defined by the following claims (and their equivalents) in which all terms are meant in their broadest reasonable sense unless otherwise indicated. Any headings utilized within the description are for convenience only and have no legal or limiting effect.

I claim:

1. A ladder leveling system, comprising:
an extension member including a channel and at least one slot, wherein said at least one slot extends through said extension member;
wherein said at least one slot is positioned substantially parallel to a longitudinal axis of said extension member;
at least one bracket including at least one aperture, wherein said at least one bracket is positioned adjacent said extension member;
wherein said channel extends between said at least one bracket and said extension member; and
at least one attachment member extending through said aperture and said at least one slot, wherein said at least one attachment member is selectively secured within said at least one slot and wherein said at least one attachment member secures said at least one bracket to said extension member.

2. The ladder leveling system of claim 1, wherein said aperture, said at least one hole and said at least one slot substantially align.

3. The ladder leveling system of claim 1, wherein said at least one slot extends through said a support portion of said extension member, wherein said support portion is opposite said bracket.

4. The ladder leveling system of claim 1, wherein said at least one slot is centrally spaced about said a support portion of said extension member, wherein said support portion is opposite said bracket.

5. The ladder leveling system of claim 1, wherein said at least one slot is comprised of an elongated structure.

6. The ladder leveling system of claim 1, wherein said bracket includes an extending portion, wherein said extending portion extends toward said extension member.

7. The ladder leveling system of claim 1, wherein said extension member includes a handle extending outwardly from said extension member.

8. The ladder leveling system of claim 1, wherein said at least one slot includes an upper slot and a lower slot.

9. The ladder leveling system of claim 8, wherein said upper slot and said lower slot are vertically stacked.

10. The ladder leveling system of claim 1, wherein said at least one bracket and said extension member form a cincture structure around said channel.

11. The ladder leveling system of claim 1, wherein a first cross section of said at least one bracket is substantially U-shaped.

12. The ladder leveling system of claim 1, wherein said at least one bracket includes an upper bracket and a lower bracket.

13. The ladder leveling system of claim 1, including a foot member, wherein said foot member is attached to a base portion of said extension member.

14. The ladder leveling system of claim 13, wherein said foot member includes a lower surface, wherein said lower surface is comprised of an inclined configuration.

15. The ladder leveling system of claim 1, wherein a second cross section of said extension member is comprised of a U-shaped configuration.

16. The ladder leveling system of claim 1, wherein a third cross section of said extension member is comprised of an I-shaped configuration.

17. The ladder leveling system of claim 1, wherein said extension member includes a sleeve portion attached to a pair of side portions of said extension member.

18. A ladder leveling system, comprising:
a first extension member including a first channel;
wherein a first leg of a ladder is positionable within said first channel;
wherein said first leg of said ladder includes a first hole extending through said leg;
a second extension member including a second channel;
wherein a second leg of said ladder is positionable within said second channel;
wherein said second leg of said ladder includes a second hole extending through said second leg;
at least one first bracket attached to said first extension member, wherein said first leg of said ladder is positionable between said at least one first bracket and said first extension member;
at least one second bracket attached to said second extension member, wherein said second leg of said ladder is positionable between said at least one second bracket and said second extension member;
wherein said first extension member includes at least one first slot extending through said first extension member and wherein said at least one first bracket includes a first aperture;
wherein said first slot is positioned about a first longitudinal axis of said first extension member;
wherein said second extension member includes at least one second slot extending through said second extension member and wherein said at least one second bracket includes a second aperture;
wherein said second slot is positioned about a second longitudinal axis of said second extension member;
at least one first attachment member extending through said first aperture, said first hole and said at least one first slot, wherein said at least one first attachment member is selectively secured about said first slot; and
at least one second attachment member extending through said second aperture, said second hole and said at least one second slot, wherein said at least one second attachment member is selectively secured about said second slot.

19. The ladder leveling system of claim 9, including:
a first foot member, wherein said first foot member is attached to a first base portion of said first extension member; and
a second foot member, wherein said second foot member is attached to a second base portion of said second extension member.

20. A ladder leveling system, comprising:
an extension member including a channel and at least one slot, wherein said at least one slot extends through said extension member;
wherein said at least one slot is positioned substantially parallel to a longitudinal axis of said extension member;
at least one bracket including at least one aperture, wherein said at least one bracket is positioned adjacent said extension member;
wherein said channel extends between said at least one bracket and said support portion;
at least one attachment member extending through said aperture and said at least one slot, wherein said at least one attachment member is selectively secured within said at least one slot and wherein said at least one attachment member secures said at least one bracket to said extension member;
wherein said aperture, said at least one hole and said at least one slot substantially align;
wherein said at least one slot extends through said a support portion of said extension member and wherein said at least one slot is centrally spaced about said support portion of said extension member, wherein said support portion is opposite said bracket;
wherein said at least one slot is comprised of an elongated structure;
wherein said at least one attachment member is threadably formed;
wherein said bracket includes an extending portion, wherein said extending portion extends toward said extension member;
wherein said at least one slot includes an upper slot and a lower slot and wherein said upper slot and said lower slot are vertically stacked;
wherein said at least one bracket and said extension member form a cincture structure around said channel;
wherein a first cross section of said at least one bracket is substantially U-shaped;
wherein said at least one bracket includes an upper bracket and a lower bracket; and
a foot member attached to a base portion of said extension member.
